(19) United States
(12) Patent Application Publication
(10) Pub. No.: US 2011/0153385 A1
(43) Pub. Date: Jun. 23, 2011

(54) DETERMINATION OF DEMAND UPLIFT VALUES FOR CAUSAL FACTORS WITH SEASONAL PATTERNS IN A CAUSAL PRODUCT DEMAND FORECASTING SYSTEM

(76) Inventors: Arash Bateni, Toronto (CA); Edward Kim, Toronto (CA)

(21) Appl. No.: 12/643,079

(22) Filed: Dec. 21, 2009

(51) Int. Cl. G06Q 10/00

(52) U.S. Cl. 705/7.31

(57) ABSTRACT

An improved method and system for forecasting product demand using a causal methodology, based on multiple regression techniques. The causal method uses both historical and future values of causal factors for causal forecasting. Historical values are used to build a causal model, i.e., to determine the influence of the causal factors upon the demand for a product, and future values are used to generate demand uplifts which applied to an initial demand forecast based upon historical product demand. The improved causal method provides different processes for the calculation of demand uplifts associated with seasonal variables, such as temperature, than typical, non-seasonal causal variables, such as product price. Demand uplifts for seasonal variables are determined from the difference between a forecast value for the seasonal variable and an average of corresponding historical, prior-year, values of the seasonal variable, and demand uplifts for non-seasonal variables are determined from the difference between a forecast value for the non-seasonal variable and an average of recent values of the non-seasonal variable.

### CROSS REFERENCE TO RELATED APPLICATIONS

This application is related to the following co-pending and commonly-assigned patent applications, which are incorporated by reference herein:

Application Ser. No. 11/613,404, entitled “IMPROVED METHODS AND SYSTEMS FOR FORECASTING PRODUCT DEMAND USING A CAUSAL METHODOLOGY,” filed on Dec. 20, 2006, by Arash Bateni, Edward Kim, Philip Liew, and J. P. Vorsanger;

Application Ser. No. 11/938,812, entitled “IMPROVED METHODS AND SYSTEMS FOR FORECASTING PRODUCT DEMAND DURING PROMOTIONAL EVENTS USING A CAUSAL METHODOLOGY,” filed on Nov. 13, 2007, by Arash Bateni, Edward Kim, Harmintar Atwal, and J. P. Vorsanger;

Application Ser. No. 11/967,645, entitled “TECHNIQUES FOR CAUSAL DEMAND FORECASTING,” filed on Dec. 31, 2007, by Arash Bateni, Edward Kim, J. P. Vorsanger, and Rong Zong; and

Application Ser. No. 12/255,696, entitled “METHODOLOGY FOR SELECTING CAUSAL VARIABLES FOR USE IN A PRODUCT DEMAND FORECASTING SYSTEM,” filed on Oct. 22, 2008, by Arash Bateni and Edward Kim.

Application Ser. No. 12/512,071, entitled “CAUSAL PRODUCT DEMAND FORECASTING SYSTEM AND METHOD USING WEATHER DATA AS CAUSAL FACTORS IN RETAIL DEMAND FORECASTING,” filed on Jul. 30, 2009, by Arash Bateni and Edward Kim.

Application Ser. No. 12/545,263, entitled “MODELING CAUSAL FACTORS WITH SEASONAL PATTERNS IN A CAUSAL PRODUCT DEMAND FORECASTING SYSTEM,” filed on Aug. 21, 2009, by Arash Bateni and Edward Kim.

### FIELD OF THE INVENTION

The present invention relates to a methods and systems for forecasting product demand using a causal methodology, based on multiple regression techniques, and in particular to an improved method for calculating demand uplifts for causal variables having seasonal patterns.

### BACKGROUND OF THE INVENTION

Accurate demand forecasts are crucial to a retailer's business activities, particularly inventory control and replenishment, and hence significantly contribute to the productivity and profit of retail organizations.

Teradata Corporation has developed a suite of analytical applications for the retail business, referred to as Teradata Demand Chain Management (DCM), which provides retailers with the tools they need for product demand forecasting, planning and replenishment. Teradata Demand Chain Management assists retailers in accurately forecasting product sales at the store/SKU (Stock Keeping Unit) level to ensure high customer service levels are met, and inventory stock at the store level is optimized and automatically replenished. Teradata DCM helps retailers anticipate increased demand for products and plan for customer promotions by providing the tools to do effective product forecasting through a responsive supply chain.

In application Ser. Nos. 11/613,404; 11/938,812; and 11/967,645, referred to above in the CROSS REFERENCE TO RELATED APPLICATIONS, Teradata Corporation has presented improvements to the DCM Application Suite for forecasting and modeling product demand during promotional and non-promotional periods. The forecasting methodologies described in these references seek to establish a cause-effect relationship between product demand and factors influencing product demand in a market environment. Such factors may include current product sales rates, seasonality of demand, product price changes, promotional activities, competitive information, and other factors. Regression models, constructed through the analysis of historical causal variable data, are used to calculate demand uplifts which are used to adjust the DCM product demand forecasts.

Application Ser. Nos. 12/512,071 and 12/545,263, referred to above, introduced the concept of using weather related causal variables as part of the casual demand forecasting framework. Variables, such as a temperature, precipitation, snow, accumulated snow, and extreme weather conditions, are highly seasonal and therefore require particular treatment to be properly modeled. This improvement described herein provides a different process for the calculation of demand uplifts for seasonal variables than typical, non-seasonal, causal variables.

### BRIEF DESCRIPTION OF THE DRAWINGS

FIG. 1 provides a high level architecture diagram of a web-based three-tier client-server computer system architecture.

FIGS. 2A and 2B provide a flow diagram illustrating a causal methodology for determining product demand forecasts including weather related data as a set of causal factors within the regression analysis and demand forecast calculations.

FIG. 3 is a flow diagram illustrating a portion of the causal methodology illustrated in FIGS. 2A and 2B for determining uplift coefficients for typical, non-seasonal related, causal factors, such as product price.

FIG. 4 illustrates the calculation of normal, or average, regular price, and price gap for use in determining uplift coefficients for the price causal factor.

FIG. 5 a flow diagram illustrating a portion of the causal methodology illustrated in FIGS. 2A and 2B for determining uplift coefficients for seasonal related causal factors.

FIG. 6 provides a graphical comparison between recorded weekly temperatures during an exemplary fifty-two week period and weekly average historical temperatures for those same fifty-two weeks.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

As stated above, the causal demand forecasting methodology seeks to establish a cause-effect relationship between product demand and factors influencing product demand in a market environment. A product demand forecast is generated by blending the various influencing factors in accordance with corresponding regression coefficients determined through the analysis of historical product demand and factor information. The multivariable regression equation can be expressed as:

LN=base+α₁var₁+α₂var₂+ . . . +αₙvarₙ Equation (1);

where LN represents demand; var₁ through varₙ represent causal variables, such as current product sales rate, seasonality of demand, product price, promotional activities, and other factors; and α₁ through αₙ represent regression coefficients determined through regression analysis using historical sales, price, promotion, and other causal data.

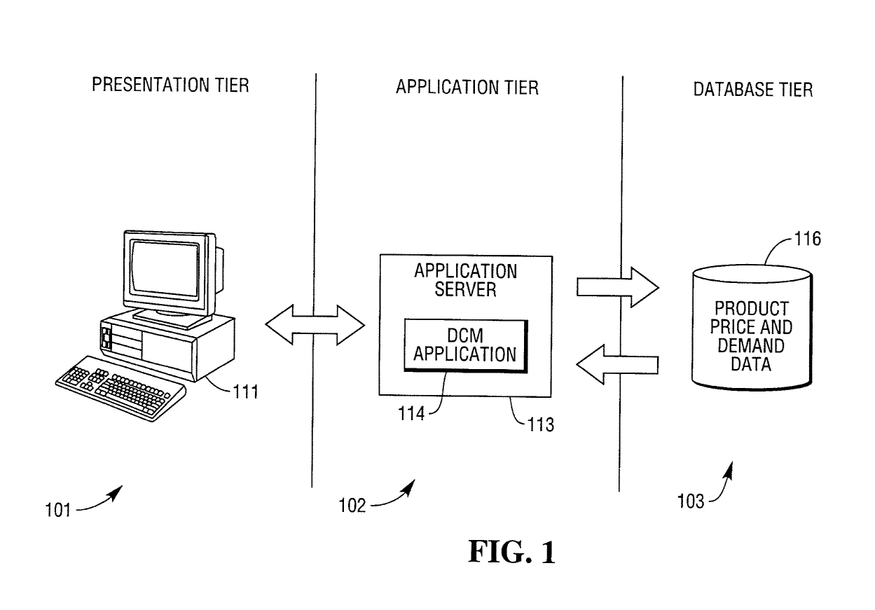

The Teradata Corporation DCM Application Suite may be implemented within a three-tier computer system architecture as illustrated in FIG. 1. The three-tier computer system architecture is a client-server architecture in which the user interface, application logic, and data storage and data access are developed and maintained as independent modules, most often on separate platforms. The three tiers are identified in FIG. 1 as presentation tier 101, application tier 102, and database access tier 103.

Presentation tier 101 includes a PC or workstation 111 and standard graphical user interface enabling user interaction with the DCM application and displaying DCM output results to the user. Application tier 103 includes an application server 113 hosting the DCM software application 114. Database tier 103 includes a database server containing a database 116 of product price and demand data accessed by DCM application 114.

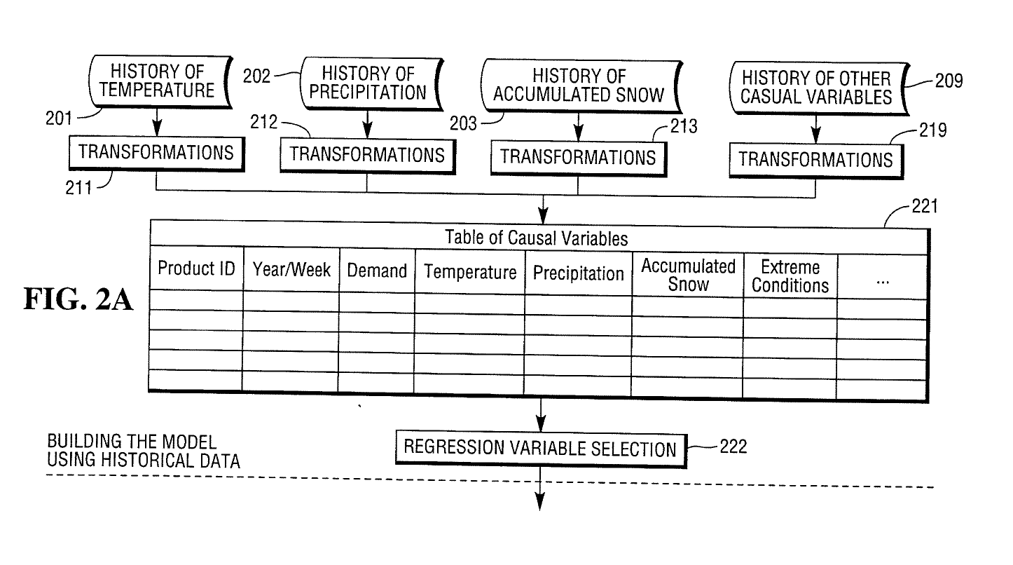

The flow diagram of FIGS. 2a and 2B illustrates an improved causal methodology for determining product demand forecasts including weather related data as a set of causal factors within the regression analysis and demand forecast calculations. These weather related factors may include temperature, precipitation, snow, accumulated snow, or extreme weather conditions. It is known that the demand of some product categories is driven by such factors. For instance, the demand for umbrellas and snow tires are driven by precipitation and accumulated snow, respectively.

In the causal demand forecasting systems described herein, and illustrated in FIGS. 2A and 2B, both historical and future values of causal factors are needed for causal forecasting. Historical values are used to build the causal model, i.e., to determine the influence of the causal factors on demand of products, and future values are needed to generate the demand forecasts using the causal model. The future values of the causal factors should be either predictable or known in advance.

The historical values of weather data are readily available. Historical and predicted weather data can be purchased through subscription to a weather service or can be downloaded from established websites. Such data is normally collected at weather stations located at airports. Therefore, the location of a retailer employing a causal demand forecasting system including weather related data as a set of causal factors should be mapped to the closest airport or weather station where weather data is collected.

In FIG. 2A, acquired historical temperature data, precipitation data, and accumulated snow data is represented by stored data 201, 202 and 203, respectively.

In steps 211, 212 and 213, stored historical temperature data 201, precipitation data 202, and accumulated snow data 203 is transformed into a format that can be fed into the DCM causal framework. For instance, the collected historical temperature is in the form of maximum, minimum, and average daily values. These values are transformed into weekly average temperatures based on the fiscal retail calendar. Other mathematical transformations may be required from case to case.

Additional weather-related historical casual factor data, not shown, may also be saved, transformed, and fed into the DCM causal framework. Other, non-weather-related, historical casual factor data, represented by stored data 209, is transformed in step 219, and fed into the DCM causal framework.

Causal factor data is compiled for each product or product category as shown by table 221. Table 221 illustrates the collection of weather related causal factor data, e.g., temperature, precipitation, accumulated snow data, and extreme conditions for a portion of a retailers product line, e.g., umbrellas, snow tires, snow shovels, sunscreen, and bottled water. The information displayed in table 221 comprises just a portion of the retailer's product line and a subset of all weather, and non-weather, related causal variables.

In step 222, causal factor historical data is examined to identify the set of causal weather factors, and other causal factors, that have statistically significant effects on historical product demand, and hence are believed to be of greatest relevance in determining product demand changes in the future, are identified. Additional detail regarding the process for selecting causal variables is provided in application Ser. No. 12/255,696, referred to above and incorporated by reference herein.

In step 223, regression analysis is performed to determine the regression coefficients for the variables selected in step 222, and to build the multivariable regression equation required for demand forecast calculation.

In step 226 of FIG. 2B, demand uplift values are determined based on the deviation of the future values 224 of the various causal factors from their “normal” or average values.

In step 227 the current weekly ARS for a product is calculated from historical demand data. In step 228, the product demand forecast is determined by blending the Average Rate of Sale (ARS) from step 227 with uplift values determined in step 226.

As stated above, the general form of the regression equation for DCM causal forecasting is:

$$L N ( demand ) = base + {\sum }_{i = 1}^{n} {α}_{i} \cdot {var}_{i} ; \qquad Equation ( 1 )$$

where varᵢ is a causal variable and αᵢ is the corresponding regression coefficient for that variable.

From Equation (1) the demand uplift for each causal variable can be determined through the following equation:

Liftᵢ^{t+1}=exp[αᵢ(varᵢ^{t+1}−varᵢ^{norm})] Equation (2).

In Equation (2), Liftᵢ^{t+1} is the uplift of the week t+1 (next week) due to variable varᵢ. This uplift is calculated based on the deviation of the week t+1 value of the causal factor from its “normal value”, i.e., the value perceived by consumers as normal condition. This deviation is measured as varᵢ^{t+1}−varᵢ^{norm}. The key to the uplift calculation is to define and quantify the normal value of causal variable varᵢ^{norm}.

The following illustrative example illustrates the difference in the normal value of typical causal factors, such as product price, and seasonal factors, such as temperature. A regression equation consisting of these two variables is described as:

LN(demand)=base+α₁·price+α₂·temp Equation (3).

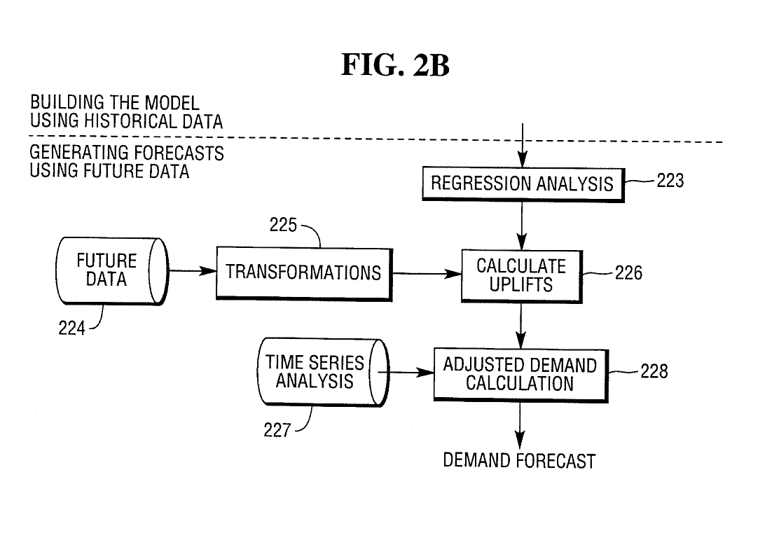

FIG. 3 is a flow diagram illustrating a portion of the causal methodology illustrated in FIGS. 2A and 2B for determining uplift coefficients for typical, non-seasonal related, causal factors, such as product price. Step 323 of FIG. 3 corresponds to step 223 of FIG. 2B, and step 326 of FIG. 3 corresponds to step 226 of FIG. 2B. Referring to FIG. 3, the price uplift is calculated in step 328 as:

Lift_{price}^{t+1}=exp[αᵢ(price^{t+1}−average(regular_price))] Equation (4).

In Equation (4) average regular price over the past recent weeks is considered as normal product price, which should not generate any uplift in demand, i.e., Lift_{price}=1. Any price below this level will typically generate an uplift of larger than one.

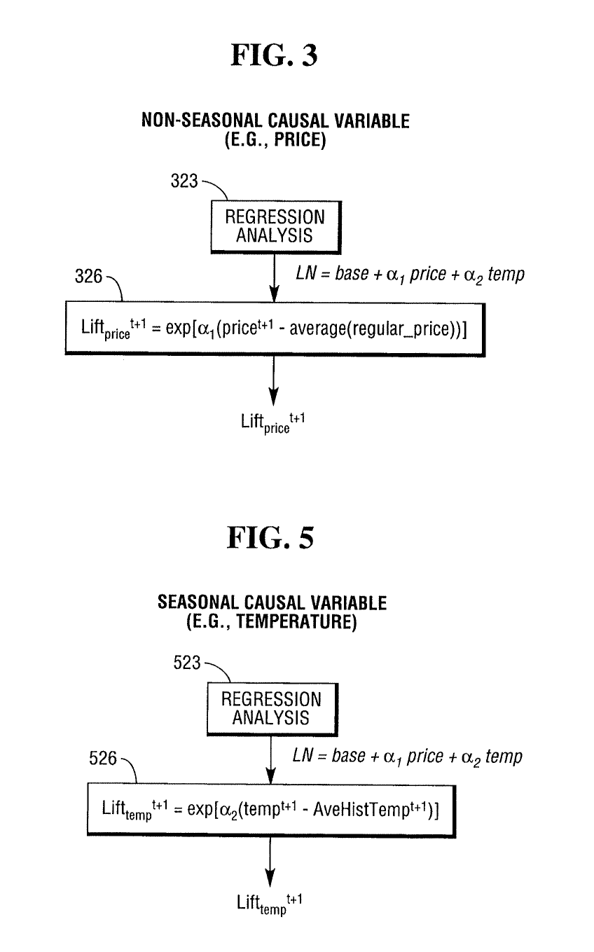

The determination of normal, or average, regular price, average(regular_price), and price gap, (price^{t+1}−average (regular_price)) is illustrated in FIG. 4. The normal piece is calculated as the average 401 of regular price over previous weeks. The price gap 403 is the deviation of the week t+1 price 405 from the normal, average, value 401. A price gap may generate an uplift in demand.

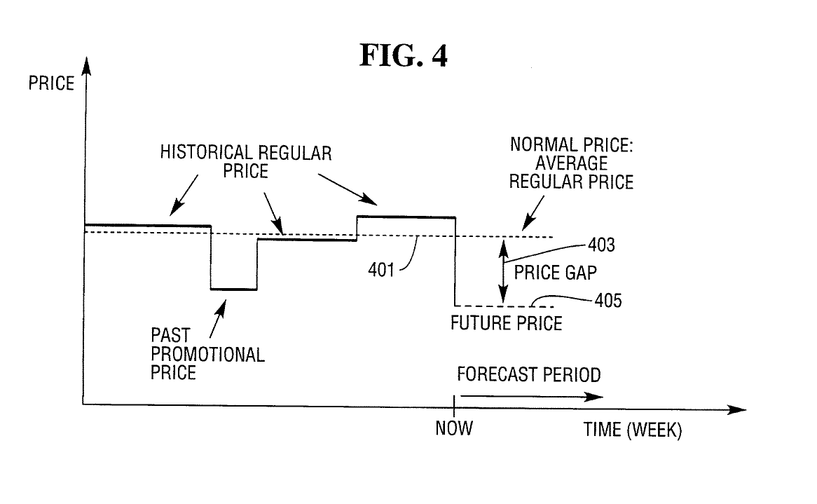

The calculation of normal values for seasonal variables, such as temperature, should be different than the calculation of normal values for non-seasonal variables. For example, the temperature of past weeks does not represent a normal condition for the current week, as the temperature changes during this period due to its seasonality. Instead, historical temperature at the same week over several previous years should be used as the normal value in the uplift calculation. Any deviation from this normal value may trigger demand uplift. Accordingly, the process for determining uplift coefficients for seasonal variables, such as temperature, is shown in FIG. 5, wherein Step 523 of FIG. 5 corresponds to step 223 of FIG. 2B, and step 526 of FIG. 5 corresponds to step 226 of FIG. 2B. Referring to FIG. 5, the demand uplift due temperature should is formulated as:

Liftₜₑₘₚ^{t+1}=exp[αᵢ(temp^{t+1}−AveHistTemp^{t+1})] Equation (5);

where AvgHistTemp^{t} is the average historical temperature for week t calculated over many years as:

$${AveHistTemp}^{t} = {\sum }_{year}^{history} {WklyTemp}^{year , t} \qquad Equation ( 6 )$$

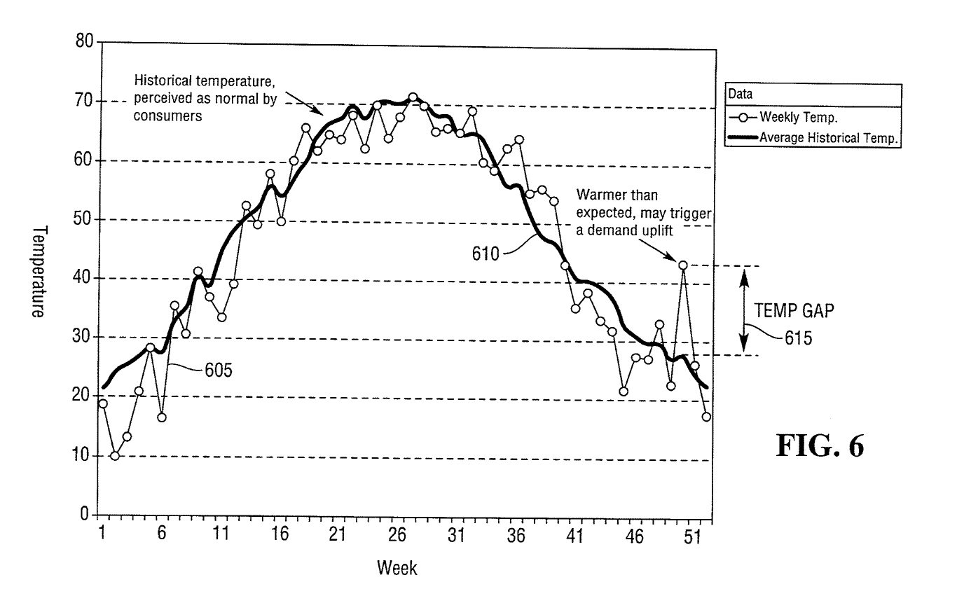

The determination of normal, or average, temperature, AveHistTemp^{t}, and temperature gap, (temp^{t+1}−AveHistTem^{t+1}) is illustrated in FIG. 6. The normal temperature is calculated for each week as the average historical average for that week, and to temperature gap is the deviation of temperature from its normal value for a given week. FIG. 6 provides a comparison between recorded and forecast weekly temperatures during an exemplary fifty-two week period, represented by line graph 605, and average historical temperatures for those same fifty-two weeks, represented by line graph 610. Large deviations from the historical averages, such as unexpectedly warm weather forecast for week 50, may trigger significant changes in the demand for certain products. The temperature gap for forecast week 50 is represented by the difference between the forecast temperature 615 and the historical average temperature for week 50, represented by reference numeral 620. This difference is illustrated by reference numeral 625. A temperature gap may generate an uplift, which may be positive or negative, in demand.

### CONCLUSION

The Figures and description of the invention provided above reveal an improved method and system for forecasting product demand using a causal demand forecasting methodology, based on multiple regression techniques This improvement described herein provides a different process for the calculation of demand uplifts for seasonal variables, such as temperature, than typical, non-seasonal, causal variables, such as product price.

Instructions of the various software routines discussed herein, such as the methods illustrated in FIGS. 2A, 2B, 3 and 5 are stored on one or more storage modules in the system shown in FIG. 1 and loaded for execution on corresponding control units or processors. The control units or processors include microprocessors, microcontrollers, processor modules or subsystems, or other control or computing devices. As used here, a “controller” refers to hardware, software, or a combination thereof. A “controller” can refer to a single component or to plural components, whether software or hardware.

Data and instructions of the various software routines are stored in respective storage modules, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software routines are loaded or transported to each device or system in one of many different ways. For example, code segments including instructions stored on floppy disks, CD or DVD media, a hard disk, or transported through a network interface card, modem, or other interface device are loaded into the device or system and executed as corresponding software modules or layers.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching. Accordingly, this invention is intended to embrace all alternatives, modifications, equivalents, and variations that fall within the spirit and broad scope of the attached claims.

What is claimed is:

1. A computer-implemented method for forecasting product demand for a product during a forecast sales period, the method comprising the steps of:
maintaining, on a computer, an electronic database of historical product demand information;
calculating, by said computer, an initial demand forecast for said product during said forecast sales period from said historical demand information;
identifying at least one seasonal causal factor influencing demand for said product;
analyzing, by said computer, said historical product demand information and historical causal variable data to determine a regression model including said at least one seasonal causal factor and a regression coefficient corresponding to said at least one seasonal causal factor;
determining, by said computer, a seasonal factor uplift coefficient for said at least one seasonal causal factor, said seasonal factor uplift coefficient being determined from a difference between a forecast value for said seasonal casual factor during said forecast sales period and an average of corresponding historical, prior-year, values of said seasonal causal factor; and
blending, by said computer, said initial demand forecast and said seasonal factor uplift coefficient to determine an adjusted product demand forecast for said product.

2. The computer-implemented method according to claim 1, wherein said at least one seasonal causal factor includes at least one of the following:
a temperature variable;
a precipitation variable;
a snow variable;
an accumulated snow variable; and
an extreme weather condition variable.

3. The computer-implemented method according to claim 1, wherein said seasonal factor uplift coefficient for said at least one seasonal causal factor is determined in accordance with the equation:
Lift^{t+1}=exp[α(var^{t+1}−var^{norm})]
where Lift^{t+1} is the uplift of forecast week t+1, var^{t+1} is the value of the seasonal causal value during the forecast week, and var^{norm} is the average of corresponding historical, prior-year, values of said seasonal causal factor.

4. A computer-implemented method for forecasting product demand for a product during a forecast sales period, the method comprising the steps of:
maintaining, on a computer, an electronic database of historical product demand information;
calculating, by said computer, an initial demand forecast for said product during said forecast sales period from said historical demand information;
identifying at least one seasonal causal factor influencing demand for said product;
identifying at least one non-seasonal causal factor influencing demand for said product;
analyzing, by said computer, said historical product demand information and historical causal variable data to determine a regression model including said at least one seasonal causal factor and said at least one non-seasonal causal factor and regression coefficients corresponding to said causal factors;
determining, by said computer, a seasonal factor uplift coefficient for said at least one seasonal causal factor, said seasonal factor uplift coefficient being determined from a difference between a forecast value for said seasonal casual factor during said forecast sales period and an average of corresponding historical, prior-year, values of said seasonal causal factor;
determining, by said computer, a non-seasonal uplift coefficient for said at least one non-seasonal causal factor, said non-seasonal uplift coefficient being determined from a difference between a forecast value for said non-seasonal casual factor during said forecast sales period and an average of recent values of said non-seasonal causal factor; and
blending, by said computer, said initial demand forecast, said seasonal uplift coefficient and said non-seasonal uplift coefficient to determine an adjusted product demand forecast for said product.

5. The computer-implemented method according to claim 4, wherein said at least one seasonal causal factor includes at least one of the following:
a temperature variable;
a precipitation variable;
a snow variable;
an accumulated snow variable; and
an extreme weather condition variable.

6. The computer-implemented method according to claim 4, wherein said at least one non-seasonal causal factor includes at least one of the following:
a product price variable; and
a product promotion variable.

7. The computer-implemented method according to claim 4, wherein said seasonal factor uplift coefficient for said at least one seasonal causal factor is determined in accordance with the equation:
Lift^{t+1}=exp[α(var^{t+1}−var^{norm})]
where Lift^{t+1} is the uplift of forecast week t+1, var^{t+1} is the value of the seasonal causal value during the forecast week, and var^{norm} is the average of corresponding historical, prior-year, values of said seasonal causal factor.

8. The computer-implemented method according to claim 4, wherein said seasonal factor uplift coefficient for said at least one non-seasonal causal factor is determined in accordance with the equation:
Lift^{t+1}=exp[α(var^{t+1}−var^{norm})]
where Lift^{t+1} is the uplift of forecast week t+1, var^{t+1} is the value of the non-seasonal causal value during the forecast week, and var^{norm} is the average of average of recent values of said non-seasonal causal factor.

9. A system for forecasting product demand for a product during a forecast sales period, the system comprising:
a computer storage device containing a database of historical product demand information for a plurality of products; and
a processor for:
calculating an initial demand forecast for said product during said forecast sales period from said historical demand information;
identifying at least one seasonal causal factor influencing demand for said product;
analyzing said historical product demand information and historical causal variable data to determine a regression model including said at least one seasonal causal factor and a regression coefficient corresponding to said at least one seasonal causal factor;
determining a seasonal factor uplift coefficient for said at least one seasonal causal factor, said seasonal factor uplift coefficient being determined from a difference between a forecast value for said seasonal casual factor during said forecast sales period and an average of corresponding historical, prior-year, values of said seasonal causal factor; and
blending said initial demand forecast and said seasonal factor uplift coefficient to determine an adjusted product demand forecast for said product.

10. The system according to claim 9, wherein said at least one seasonal causal factor includes at least one of the following:
a temperature variable;
a precipitation variable;
a snow variable;
an accumulated snow variable; and
an extreme weather condition variable.

11. The system according to claim 9, wherein said seasonal factor uplift coefficient for said at least one seasonal causal factor is determined in accordance with the equation:
Lift^{t+1}=exp[α(var^{t+1}−var^{norm})]
where Lift^{t+1} is the uplift of forecast week t+1, var^{t+1} is the value of the seasonal causal value during the forecast week, and var^{norm} is the average of corresponding historical, prior-year, values of said seasonal causal factor.

12. A system for forecasting product demand for a product during a forecast sales period, the system comprising:
a computer storage device containing a database of historical product demand information for a plurality of products; and
a processor for:
calculating an initial demand forecast for said product during said forecast sales period from said historical demand information;
identifying at least one seasonal causal factor influencing demand for said product;
identifying at least one non-seasonal causal factor influencing demand for said product;
analyzing said historical product demand information and historical causal variable data to determine a regression model including said at least one seasonal causal factor and said at least one non-seasonal causal factor and regression coefficients corresponding to said causal factors;
determining a seasonal factor uplift coefficient for said at least one seasonal causal factor, said seasonal factor uplift coefficient being determined from a difference between a forecast value for said seasonal casual factor during said forecast sales period and an average of corresponding historical, prior-year, values of said seasonal causal factor;
determining a non-seasonal uplift coefficient for said at least one non-seasonal causal factor, said non-seasonal uplift coefficient being determined from a difference between a forecast value for said non-seasonal casual factor during said forecast sales period and an average of recent values of said non-seasonal causal factor; and
blending said initial demand forecast, said seasonal uplift coefficient and said non-seasonal uplift coefficient to determine an adjusted product demand forecast for said product.

13. The system according to claim 12, wherein said at least one seasonal causal factor includes at least one of the following:
a temperature variable;
a precipitation variable;
a snow variable;
an accumulated snow variable; and
an extreme weather condition variable.

14. The system according to claim 12, wherein said at least one non-seasonal causal factor includes at least one of the following:
a product price variable; and
a product promotion variable.

15. The system according to claim 12, wherein said seasonal factor uplift coefficient for said at least one seasonal causal factor is determined in accordance with the equation:
Lift^{t+1}=exp[α(var^{t+1}−var^{norm})]
where Lift^{t+1} is the uplift of forecast week t+1, var^{t+1} is the value of the seasonal causal value during the forecast week, and var^{norm} is the average of corresponding historical, prior-year, values of said seasonal causal factor.

16. The system according to claim 12, wherein said seasonal factor uplift coefficient for said at least one non-seasonal causal factor is determined in accordance with the equation:
Lift^{t+1}=exp[α(var^{t+1}−var^{norm})]
where Lift^{t+1} is the uplift of forecast week t+1, var^{t+1} is the value of the non-seasonal causal value during the forecast week, and var^{norm} is the average of average of recent values of said non-seasonal causal factor.

17. A computer program, stored on a tangible storage medium, for forecasting demand for a product, the program including executable instructions that cause a computer to:
calculate an initial demand forecast for said product during a forecast sales period from historical demand information maintained within an electronic database on said computer;
calculate an initial demand forecast for said product during said forecast sales period from said historical demand information;
identify at least one seasonal causal factor influencing demand for said product;
analyze said historical product demand information and historical causal variable data to determine a regression model including said at least one seasonal causal factor and a regression coefficient corresponding to said at least one seasonal causal factor;
determine a seasonal factor uplift coefficient for said at least one seasonal causal factor, said seasonal factor uplift coefficient being determined from a difference between a forecast value for said seasonal casual factor during said forecast sales period and an average of corresponding historical, prior-year, values of said seasonal causal factor; and
blend said initial demand forecast and said seasonal factor uplift coefficient to determine an adjusted product demand forecast for said product.

18. The computer program, stored on a tangible storage medium, for forecasting demand for a product according to claim 17, wherein said at least one seasonal causal factor includes at least one of the following:
a temperature variable;
a precipitation variable;
a snow variable;
an accumulated snow variable; and
an extreme weather condition variable.

19. The computer program, stored on a tangible storage medium, for forecasting demand for a product according to claim 17, wherein said seasonal factor uplift coefficient for said at least one seasonal causal factor is determined in accordance with the equation:
Lift^{t+1}=exp[α(var^{t+1}−var^{norm})]
where Lift^{t+1} is the uplift of forecast week t+1, var^{t+1} is the value of the seasonal causal value during the forecast week, and var^{norm} is the average of corresponding historical, prior-year, values of said seasonal causal factor.

20. A computer program, stored on a tangible storage medium, for forecasting demand for a product, the program including executable instructions that cause a computer to:
calculate an initial demand forecast for said product during a forecast sales period from historical demand information maintained within an electronic database on said computer;
calculate an initial demand forecast for said product during said forecast sales period from said historical demand information;
identify at least one seasonal causal factor influencing demand for said product;
identify at least one non-seasonal causal factor influencing demand for said product;
analyze said historical product demand information and historical causal variable data to determine a regression model including said at least one seasonal causal factor and said at least one non-seasonal causal factor and regression coefficients corresponding to said causal factors;
determine a seasonal factor uplift coefficient for said at least one seasonal causal factor, said seasonal factor uplift coefficient being determined from a difference between a forecast value for said seasonal casual factor during said forecast sales period and an average of corresponding historical, prior-year, values of said seasonal causal factor;
determine a non-seasonal uplift coefficient for said at least one non-seasonal causal factor, said non-seasonal uplift coefficient being determined from a difference between a forecast value for said non-seasonal casual factor during said forecast sales period and an average of recent values of said non-seasonal causal factor; and
blend said initial demand forecast, said seasonal uplift coefficient and said non-seasonal uplift coefficient to determine an adjusted product demand forecast for said product.

21. The computer program, stored on a tangible storage medium, for forecasting demand for a product according to claim 20, wherein said at least one seasonal causal factor includes at least one of the following:
a temperature variable;
a precipitation variable;
a snow variable;
an accumulated snow variable; and
an extreme weather condition variable.

22. The computer program, stored on a tangible storage medium, for forecasting demand for a product according to claim 20, wherein said at least one non-seasonal causal factor includes at least one of the following:
a product price variable; and
a product promotion variable.

23. The computer program, stored on a tangible storage medium, for forecasting demand for a product according to claim 20, wherein said seasonal factor uplift coefficient for said at least one seasonal causal factor is determined in accordance with the equation:
Lift^{t+1}=exp[α(var^{t+1}−var^{norm})]
where Lift^{t+1} is the uplift of forecast week t+1, var^{t+1} is the value of the seasonal causal value during the forecast week, and var^{norm} is the average of corresponding historical, prior-year, values of said seasonal causal factor.

24. The computer program, stored on a tangible storage medium, for forecasting demand for a product according to claim 20, wherein said seasonal factor uplift coefficient for said at least one non-seasonal causal factor is determined in accordance with the equation:
Lift^{t+1}=exp[α(var^{t+1}−var^{norm})]
where Lift^{t+1} is the uplift of forecast week t+1, var^{t+1} is the value of the non-seasonal causal value during the forecast week, and var^{norm} is the average of average of recent values of said non-seasonal causal factor.
